(19) United States
(12) Patent Application Publication
(10) Pub. No.: US 2010/0158196 A1
(43) Pub. Date: Jun. 24, 2010

(54) Radiation beam blocker with non-cylindrical through-hole causing reduced geometric unsharpness in radiographic image, and method for the preparation thereof

(76) Inventor: Martin Born, Cocoa Beach, FL (US)

Correspondence Address: MARTIN BORN, UNIT B207, 3180 NORTH ATLANTIC AVE, COCOA BEACH, FL, 32931, US

(21) Appl. No.: 12/317,335

(22) Filed: Dec. 23, 2008

(51) Int. Cl. G21K 1/00; B21D 39/03

(52) U.S. Cl. 378/161; 29/428

(57) ABSTRACT

An aperture plate, consisting of a beam blocker with a through-hole in the micrometer diameter range, is positioned in the primary radiation beam between the radiation initiation point and the specimen. The micro-hole extends along the thickness of the beam blocker, is non-cylindrical with a narrow center region, and allows photons emitted by any given sub-region of the initiation point to pass through the beam blocker, if those photons propagate along a specific vector. Therefore, any specimen feature of interest can only be exposed by photons from a sub-region of the initiation point. This results in an effective radiation initiation point size reduction, and allows for examinations of large or dense objects with hard x-rays or high intensity gamma radiation, while at the same time minimizing geometric unsharpness in the resulting radiographic images. The micro-hole configuration can be controlled by stacking and securing multiple plates with various micro-hole diameters.

Radiographic imaging applications in medical or industrial applications utilize x-ray generating devices, such as x-ray machines with x-ray tubes or linear accelerators, also called “Linatrons”, or alternatively utilize radioactive isotopes which emit gamma radiation. In all such applications, the radiation is emitted at one location, then travels in straight lines through an object (scatter can be disregarded in this context), such as the patient or the industrial specimen to be inspected, where it is attenuated based on local material properties, before the remaining radiation finally reaches a radiation detection medium such as traditional film, digital linear or area detectors with scintillators and photodiodes, fluorescent screens or other detector types. The image which is created on the radiation detection medium is therefore a projection of the specimen. If the radiation spreads within a cone or fan beam, and the specimen or any of its features are not in direct contact with the radiation detection medium, then the projection image of the affected features will be magnified according to the optical and geometric parameters of the application. Also, in this case, the resulting projection image of those features, which are not in direct contact with the radiation detection medium, will exhibit an inherent unsharpness, caused by the optical and geometric parameters of the application. The Geometric Unsharpness in radiographic imaging is also called “Penumbra” or U_{g} and can be quantified by the following formula:

Penumbra U_{g}=(A×B)/C

with:

A=Effective size of radiation initiation point

B=Distance between source-side of specimen and radiation detection medium

C=Distance between radiation initiation point and source-side of specimen

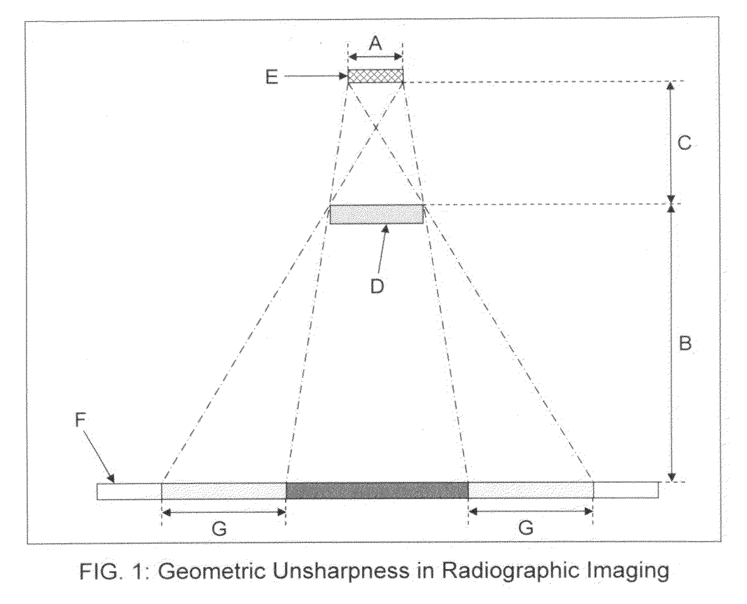

Refer to Drawing Sheet 1/11, FIG. 1.

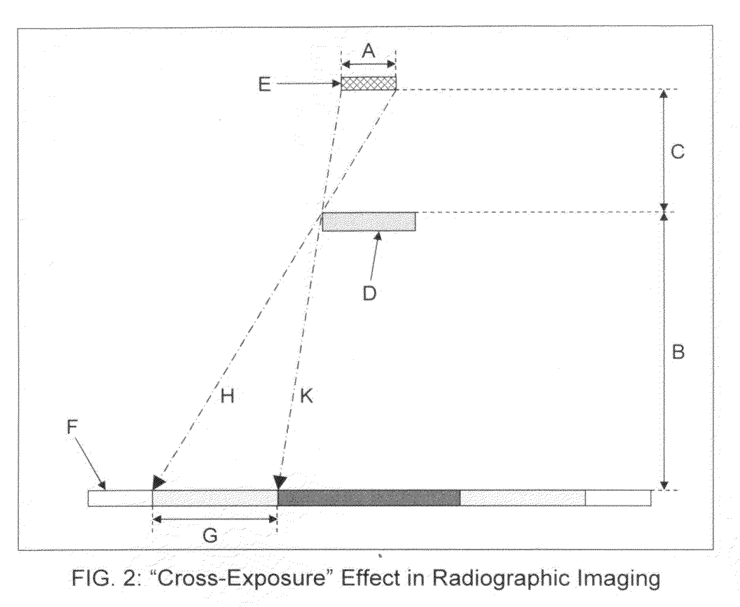

This formula shows that geometric unsharpness is directly proportional to the size of the radiation initiation point, which is why it is desirable to always utilize the smallest possible radiation initiation point in order to minimize geometric unsharpness in the projection image. Geometric unsharpness in a projection image is caused by the fact that individual radiation beams, which originate in different sub-regions of the large radiation initiation point, can follow slightly different propagation vectors but still intersect at the same location within the specimen. This effect is from here on referred to as “cross-exposure”. The resulting projection images of a feature at said location caused by those individual, intersecting or crossing radiation beams will therefore be directed towards and created in slightly different locations on the radiation detection medium, which results in image unsharpness. Refer to Drawing Sheet 2/11, FIG. 2. This effect grows with the distance between the specimen feature and the radiation detection medium, as well as with the size of the radiation initiation point. This effect can be reduced by utilizing smaller radiation initiation points, but associated limitations are described below.

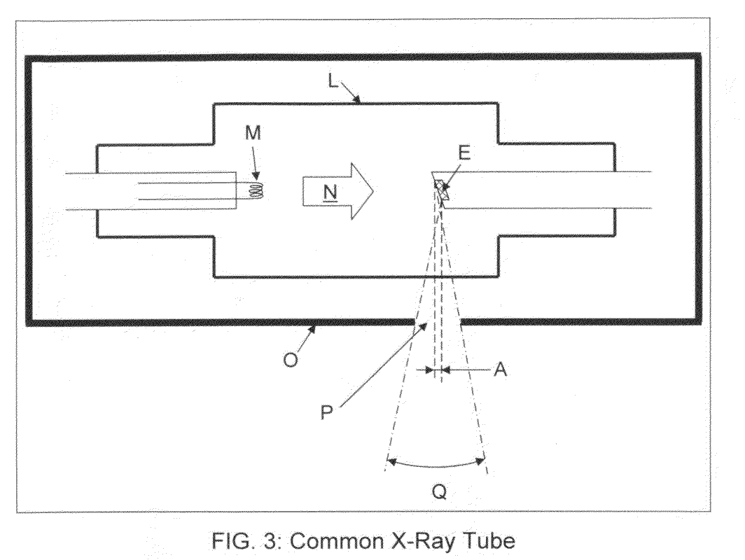

For common x-ray machines and linatrons, the radiation initiation point is usually called the “Focal Spot”. The focal spot size is related to the physical size of the target within the x-ray generating device. High-speed electrons impinge on this target, which slows them down, and a portion of their kinetic energy is released in the form of x-ray radiation or x-ray photons. The temperature of the target increases significantly during electron bombardment, and it requires cooling to prevent it from melting. Therefore, although it would be desirable to build the target, i.e. the focal spot, as small as possible, in actuality the target must have a certain size (usually in the millimeter range) to ensure thermal and structural stability. Refer to Drawing Sheet 3/11, FIG. 3.

The quality (i.e. penetrating ability) of the emitted x-ray radiation is related to the velocity with which the electrons impact the target. The quantity of the emitted x-ray radiation (i.e. quantity of x-ray photons generated) is related to the amount of electrons impacting the target. For x-ray tubes, photon quality is usually expressed as the voltage across the electron beam in the x-ray tube in keV or MeV (kilo or Mega electron-Volt), while photon quantity is usually expressed as the current across the electron beam in the x-ray tube in mA (milli-Amperage).

Common “Microfocus” x-ray machines utilize very small targets and focal spots (usually in the micrometer range), which is made possible by limiting the electron velocity and amount. As a result, the geometric unsharpness of the radiographic image is minimal, however, the quality and quantity of the emitted x-ray radiation is also limited, which makes microfocus machines only useful for the inspection of small or low-density specimens.

Most x-ray machines emit a cone beam of radiation which exposes the region of interest of the specimen. The opening angle of the cone beam is controlled by a circular window in the x-ray tube head (among other things), which is located at a fixed distance from the focal spot, while the focal spot represents the tip of the cone.

For applications that utilize radioactive isotopes, the size of the radiation initiation point is identical to the physical dimension of the isotope particle itself. The quantity of the emitted gamma radiation or gamma photons is also directly related to the physical size of the isotope particle. Therefore, although it would be desirable to keep the isotope particle as small as possible to minimize geometric unsharpness, in actuality it must have a certain size (usually in the millimeter range) to ensure reasonable gamma radiation quantity. The gamma ray photon quality follows characteristic values specific for each isotope material, usually expressed in keV or MeV, and gamma ray photon quantity is defined by the size of the isotope, its decay characteristics, and its activity in disintegrations per second, usually expressed as Ci (“Curies”).

This ultimately leads to the problem that most radiographic inspection or examination applications of large or dense objects, which require high quality radiation, also called “hard” radiation, and/or high radiation quantities, also called high “flux”, are limited to either large x-ray focal spots or large isotopes, which always results in undesirable geometric unsharpness in the radiographic image. This is the case for industrial inspection and nondestructive testing applications where the specimen is made of metal or other highly attenuating materials, and where the specimen thickness or density is such that only high quality radiation or photons, and/or high radiation or photon quantities can effectively penetrate it.

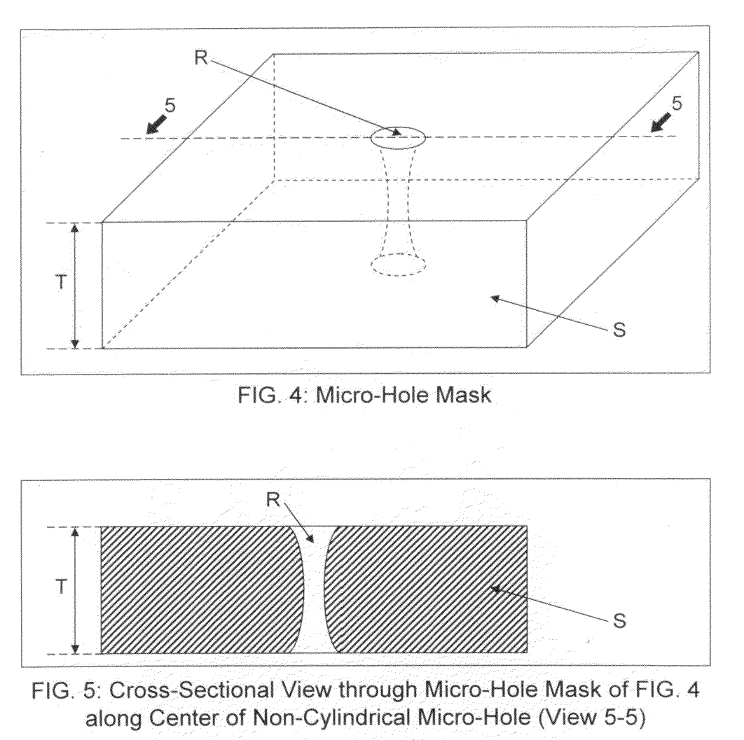

The invention claimed here can overcome this limitation by placing an aperture in the primary radiation beam, preferably near the radiation initiation point. The aperture is a beam blocker with a small through-hole (e.g. in the micrometer diameter range). The beam blocker is made of material, which is highly opaque to radiation, and is sufficiently thick to block a large amount of radiation. The diameter of the micro-hole can vary along the thickness of the beam blocker (i.e. along the center axis of the radiation cone beam) in a linear or non-linear fashion, resulting in a non-cylindrical hole with a center region that is narrower and has a smaller diameter then the entry and exit regions of the hole. Refer to Drawing Sheet 4/11, FIGS. 4 and 5.

This allows for certain radiation beams emitted by the original radiation initiation point to enter the micro-hole, pass through its narrow center region, exit the micro-hole, and to propagate towards the specimen. The individual beams that exit the micro-hole, propagate towards the specimen, and therefore make up the entire resulting radiation cone used for the application, have originated in different sub-regions of the original radiation initiation point, which is highly advantageous because it eliminates the root cause of geometric image unsharpness described earlier.

### SPECIFICATION SECTION 6—BRIEF SUMMARY OF THE INVENTION

Due to various reasons described in greater detail in the Background section, x-ray and gamma ray initiation points for industrial or medical radiographic examination applications are required to be of a certain physical size. An X-ray machine radiation initiation point, usually called “Focal Spot”, must be of a certain size (in the millimeter range) in order to tolerate the heat produced during electron bombardment, especially during the generation of highly energetic or hard x-rays. Similarly, radioisotopes must often be of a certain size (in the millimeter range) in order to produce a reasonable amount of radiation, because the photon output quantity of a gamma ray source is determined by the amount of atoms that decay or disintegrate within it over time.

The size of the radiation initiation point is directly proportional to the magnitude of the “cross-exposure” effect, as well as to the inherent geometric unsharpness, also called “Penumbra” or U_{g}, of the resulting radiographic image, refer to Drawing Sheet 1/11, FIG. 1 and Drawing Sheet 2/11, FIG. 2, as well as additional explanations in the Background section.

In accordance with the present invention, a beam blocker with a small through-hole in the micrometer diameter range (from here on referred to as “Micro-Hole Mask”) is positioned in the primary radiation beam emitted by an x-ray machine, linatron or radioactive isotope. The micro-hole mask is located between the radiation initiation point and the specimen under examination, preferably as close to the radiation initiation point as possible, e.g. attached to the tube window on the outside of a common x-ray tube head, or installed inside the tube head between the target and the tube window.

The beam blocker is made of material, which is highly opaque to radiation, has a high radiation attenuation coefficient and/or a high atomic Z-number (i.e. high number of protons per nucleus), and is sufficiently thick to block a large amount of radiation.

The micro-hole extends along the thickness of the beam blocker, and allows certain photons within the primary radiation beam to pass through the beam blocker without being attenuated. The diameter of the micro-hole varies along the thickness of the beam blocker. The primary and most essential feature of the micro-hole is the fact that the center region is narrower and has a smaller diameter than the entry and exit holes.

An exemplary and simplified micro-hole configuration would resemble two opposing cones that share an overlapping common cone tip, which acts as a narrow region in the center. This exemplary hole configuration exhibits a diameter that varies along the thickness of the beam blocker, and roughly resembles two opposing funnels that share their small exit holes, forming a hole with a bow-tie-shaped cross-section.

In general, however, the diameter of the micro-hole can vary in a linear or non-linear fashion, and the edges of the micro-hole can be curved or straight. Refer to Drawing Sheet 4/11, FIGS. 4 and 5.

The shape of the micro-hole does not have to be symmetric around a common hole center axis, and the micro-hole can also have any irregular or asymmetric shape, including but not limited to elliptical, non-rounded, partially elongated, or angular shapes.

This hole configuration, having a center region that is narrower than the entry and exit holes, allows radiation emitted from a sub-region of the focal spot or the isotope to pass through the beam blocker without being attenuated, if those radiation photons from that sub-region also travel along a specific acceptable range of propagation directions. Other photons that are emitted from the same sub-region but which travel in other directions are not able to pass through the micro-hole and are attenuated by the beam blocker.

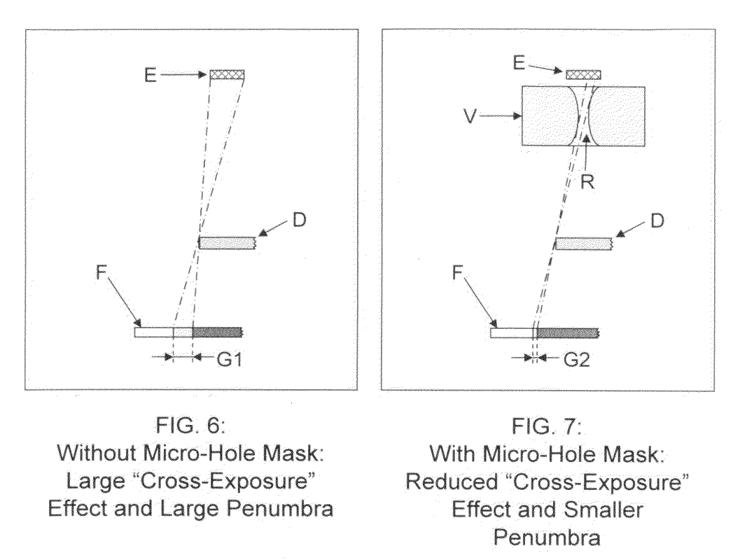

As a result, the micro-hole allows for certain radiation beams emitted by the original radiation initiation point to enter the micro-hole, pass through its narrow center region, exit the micro-hole, and to propagate towards the specimen without being attenuated. The individual beams that exit the micro-hole, propagate towards the specimen, and therefore make up the entire resulting radiation cone used for the application, have originated in different sub-regions of the original radiation initiation point. Therefore, any given specimen feature of interest can only be reached and exposed by photons from a specific sub-region of the original radiation initiation point, and thus the micro-hole reduces the “cross-exposure” effect described earlier in the Background section. The narrow region of the micro-hole therefore acts as the new effective radiation initiation point for the application, which is smaller than the original radiation initiation point, i.e. the x-ray machine's focal spot. This is highly advantageous because it eliminates the root cause of geometric unsharpness described earlier. Refer to Drawing Sheet 5/11, FIGS. 6 and 7.

It is desirable that all or most sub-regions of the focal spot or the isotope can emit photons that can pass through the micro-hole without being attenuated as long as these photons travel within the appropriate range of directions for each sub-region, so that the entire active area of the focal spot or isotope is utilized for the application.

While a different cylindrical hole with constant diameter would result in an undesirable straight laser-like radiation beam, the hole configuration described here, which can be shaped approximately like two opposing cones that are merged at their tips, allows for a radiation beam in the shape of a traditional cone beam to exit the narrow center region of the micro-hole, which is then used for the application.

While this micro-hole mask reduces the total amount of radiation photons within the primary beam, it does not affect the quality of those photons, which are passing through the micro-hole.

The resulting small effective initiation point defined by the narrow section within the micro-hole, coupled with high quality photons emitted by the original x-ray machine focal spot, linatron, or isotope, allows for examinations that combine high quality radiation with effective initiation points that are significantly smaller than those commonly used to date. As a result, reducing the effective size of the radiation initiation point of an x-ray machine, linatron, or isotope, according to this invention, allows for examinations of large or dense objects with hard x-rays or high intensity gamma radiation, while at the same time minimizing geometric unsharpness in the radiographic image.

The micro-hole mask can be utilized for static and dynamic radiographic, radioscopic, radiologic, digital imaging, nonfilm imaging, tomographic and laminographic applications. Furthermore, it can be used with any radiation-generating device and possibly attached to such devices, as long as the micro-hole is accurately aligned with the existing radiation initiation point.

Because the micro-hole mask blocks a portion of the radiation photons within the primary beam and only allows the remaining portion of the primary beam to pass through the micro-hole, it also acts as a beam collimator. This can result in a reduced need for radiation shielding components such as radiation barriers, reduced personnel exposure to hazardous shielding substances such as lead, and a reduced exposure risk for personnel.

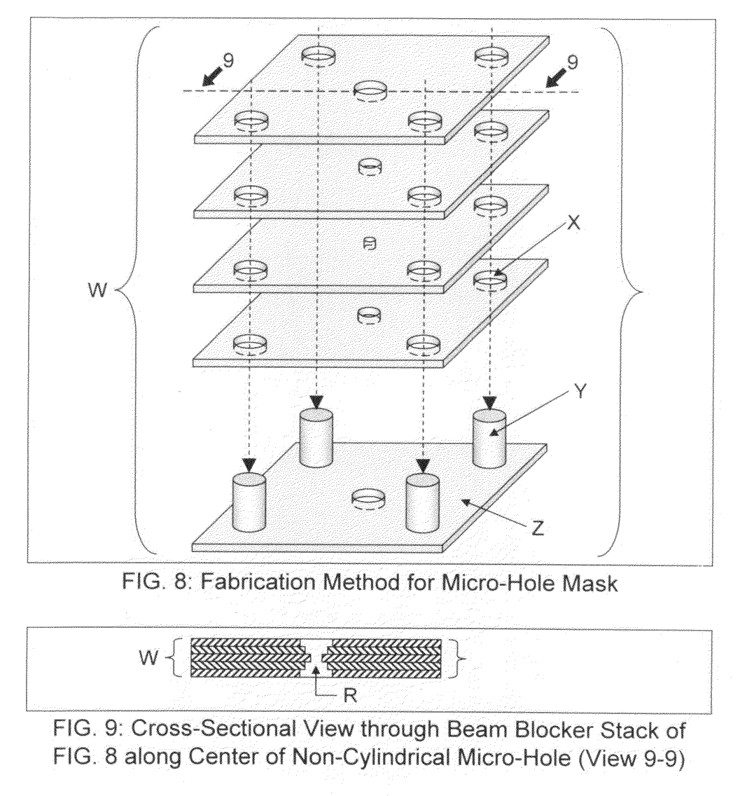

The envelope of the radiation beams or vectors exiting the micro-hole mask must be such that the detection medium in use is sufficiently exposed to radiation. Furthermore, the micro-hole design and its diameter configuration must be designed to create an effective initiation point of the desired size, down to a few micrometers or even in the sub-micrometer range, depending on the application. To accomplish such adjustments, the micro-hole mask and its hole-diameter design can be varied and controlled by stacking and securing multiple plates with various hole diameters on top of each other, while the micro-holes in all plates are accurately aligned with each other, for example to share a common hole center axis. Refer to Drawing Sheet 6/11, FIGS. 8 and 9.

### SPECIFICATION SECTION 7—BRIEF DESCRIPTION OF THE SEVERAL VIEWS OF THE DRAWING

Drawing Sheet 1/11, FIG. 1: Geometric Unsharpness in Radiographic Imaging

Drawing Sheet 2/11, FIG. 2: “Cross-Exposure” Effect in Radiographic Imaging

Drawing Sheet 3/11, FIG. 3: Common X-Ray Tube

Drawing Sheet 4/11, FIG. 4: Micro-Hole Mask

Drawing Sheet 4/11, FIG. 5: Cross-Sectional View through Micro-Hole Mask of FIG. 4 along Center of Non-Cylindrical Micro-Hole (View 5-5)

Drawing Sheet 5/11, FIG. 6: Without Micro-Hole Mask: Large “Cross-Exposure” Effect and Large Penumbra

Drawing Sheet 5/11, FIG. 7 (Also to be used as Front Page View): With Micro-Hole Mask: Reduced “Cross-Exposure” Effect and Smaller Penumbra

Drawing Sheet 6/11, FIG. 8: Fabrication Method for Micro-Hole Mask

Drawing Sheet 6/11, FIG. 9: Cross-Sectional View through Beam Blocker Stack of FIG. 8 along Center of Non-Cylindrical Micro-Hole (View 9-9)

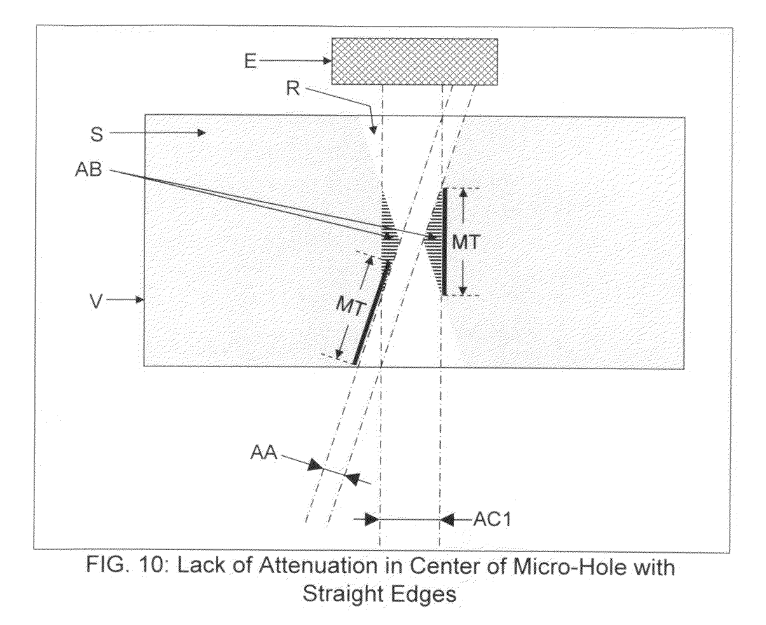

Drawing Sheet 7/11, FIG. 10: Lack of Attenuation in Center of Micro-Hole with Straight Edges

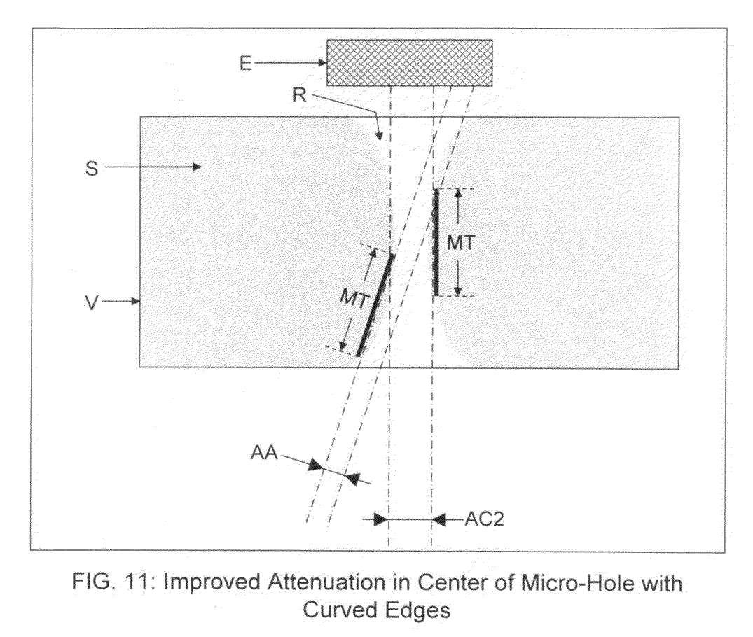

Drawing Sheet 8/11, FIG. 11: Improved Attenuation in Center of Micro-Hole with Curved Edges

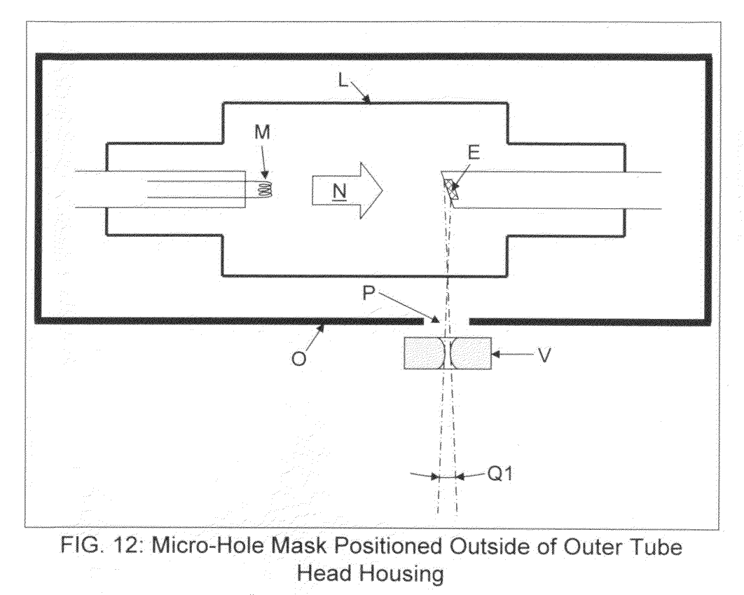

Drawing Sheet 9/11, FIG. 12: Micro-Hole Mask Positioned Outside of Outer Tube Head Housing

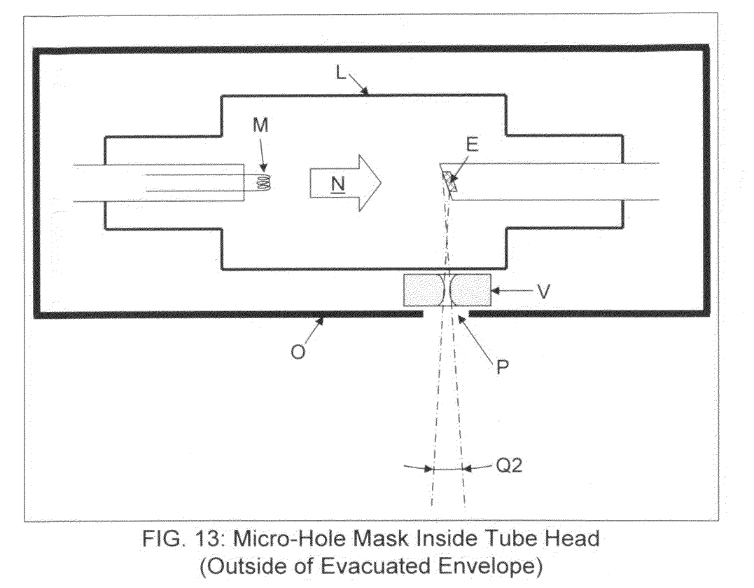

Drawing Sheet 10/11, FIG. 13: Micro-Hole Mask Inside Tube Head (Outside of Evacuated Envelope)

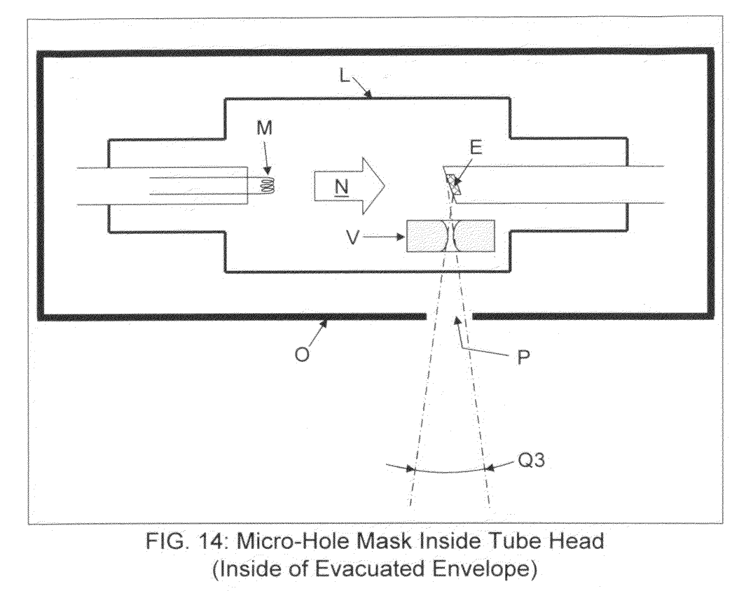

Drawing Sheet 11/11, FIG. 14: Micro-Hole Mask Inside Tube Head (Inside of Evacuated Envelope)

### SPECIFICATION SECTION 8—DETAILED DESCRIPTION OF THE INVENTION

Geometric unsharpness in a projection image is caused by the fact that individual radiation beams which originate in different sub-regions of the large radiation initiation point can follow slightly different propagation vectors but still intersect or cross at the same location within the specimen. In this document this effect is referred to as “cross-exposure”. The resulting projection images of a feature at said location caused by those individual, intersecting or crossing radiation beams will therefore be directed towards and created in slightly different locations on the radiation detection medium, which results in image unsharpness.

Refer to Drawing Sheet 1/11, FIG. 1 and Drawing Sheet 2/11, FIG. 2, in which:
A represents the effective size of the original radiation initiation point, also called focal spot
B represents the distance between the source-side of specimen D and the radiation detection medium F
C represents the distance between the original radiation initiation point E and the source-side of specimen D
D represents the specimen
E represents the original radiation initiation point
F represents the radiation detection medium
G represents the Penumbra, also called Geometric Unsharpness or U_{g}
H and K represent individual radiation beams which intersect at a feature within specimen D and cause projection images of said feature in different locations on the radiation detection medium F, resulting in Penumbra G

In accordance with the present invention, a radiation beam blocker with a small through-hole in the millimeter to sub-micrometer diameter range (from here on referred to as “Micro-Hole Mask”) is positioned in the primary radiation beam emitted by an x-ray machine, linatron or radioactive isotope. The micro-hole mask is located between the radiation initiation point and the specimen under examination, preferably as close to the radiation initiation point as possible.

The beam blocker is made of material, which is highly opaque to x- and/or gamma radiation, and/or has a high x- and/or gamma radiation attenuation coefficient, and/or has a high atomic Z-number (i.e. high number of protons per nucleus). The beam blocker must be sufficiently thick to attenuate the desired amount of radiation. The beam blocker can be made of metals, metal alloys, non-metals, composites, plastics, or other materials that meet the above criteria.

The micro-hole extends along the thickness of the beam blocker, and allows certain photons within the primary radiation beam to pass through the beam blocker without being attenuated. The diameter and shape of the micro-hole varies along the thickness of the beam blocker (i.e. along the center axis of the radiation beam) in a linear or non-linear fashion. The primary and most essential feature of the micro-hole is the fact that the center region is narrower and has a smaller diameter than the entry and exit holes.

An exemplary and simplified micro-hole configuration would resemble two opposing cones that share an overlapping common cone tip, which acts as a narrow region in the center. This exemplary hole configuration exhibits a diameter that varies along the thickness of the beam blocker, and roughly resembles two opposing funnels that share their small exit holes, forming a hole with a bow-tie-shaped cross-section.

In general, however, the diameter of the micro-hole can vary in a linear or non-linear fashion, and the edges of the micro-hole can be curved or straight.

The shape of the micro-hole does not have to be symmetric around a common hole center axis, and the micro-hole can also have any irregular or asymmetric shape, including but not limited to elliptical, non-rounded, partially elongated, or angular shapes.

Refer to Drawing Sheet 4/11, FIGS. 4 and 5, in which:
R represents the micro-hole
S represents the radiation beam blocker material
T represents the beam blocker thickness

This hole configuration, having a center region that is narrower than the entry and exit holes, allows radiation emitted from a sub-region of the focal spot or the isotope to pass through the beam blocker without being attenuated, if those radiation photons from that sub-region also travel along a specific acceptable range of propagation directions. Other photons that are emitted from the same sub-region but which travel in other directions are not able to pass through the micro-hole and are attenuated by the beam blocker.

The micro-hole allows for certain radiation beams emitted by the original radiation initiation point to enter the micro-hole, pass through its narrow center region, exit the micro-hole, and to propagate towards the specimen without being attenuated. Photons emitted by any given sub-region of the original radiation initiation point can only pass through the micro-hole if they propagate along a specific direction. The individual beams or radiation vectors exiting the micro-hole and propagating towards the specimen have originated in different sub-regions of the original radiation initiation point. Therefore, any given specimen feature of interest can only be reached and exposed by photons or radiation beams that were emitted by a specific sub-region of the original radiation initiation point, and the micro-hole therefore reduces the “cross-exposure” effect. The narrow region of the micro-hole acts as the new effective radiation initiation point for the application, which is smaller than the original radiation initiation point. This is highly advantageous because it reduces the root cause of geometric unsharpness described earlier.

Refer to Drawing Sheet 5/11, FIGS. 6 and 7, in which:
D represents the specimen
E represents the original radiation initiation point
F represents the radiation detection medium
G1 represents the large Penumbra in an application without micro-hole mask
G2 represents the small Penumbra in the same application with micro-hole mask
R represents the micro-hole
V represents the micro-hole mask

Depending on the micro-hole design and its location in relation to the radiation initiation point, either the entire focal spot or isotope, or only sub-regions of the focal spot or isotope, can emit photons that can pass through the micro-hole without being attenuated, as long as these photons travel in the appropriate range of propagation directions for each sub-region.

The shape of the micro-hole cross-section must be chosen such that any unwanted radiation beam outside of the desired beam envelope encounters enough beam blocker material with an accumulated length or thickness sufficient to shield and block those unwanted radiation beams.

As described earlier, the edges of the micro-hole can be curved or straight. A straight bow-tie cross-section has the disadvantage of having a center section in which radiation beams that propagate parallel to the central hole axis can easily penetrate the thin beam blocker walls which define the narrow hole region in the middle of the bow-tie. This results in lack of attenuation of the primary beam, lack of effectiveness of the micro-hole mask, and increased geometric unsharpness.

This is depicted in Drawing Sheet 7/11, FIG. 10, in which:
E represents the original radiation initiation point
S represents the radiation beam blocker material
V represents the micro-hole mask
R represents the micro-hole
MT represents the Minimum accumulated Thickness of beam blocker material S required to satisfactory attenuate unwanted radiation beams outside of the micro-hole R
AA represents the maximum spacing between angled radiation beams that are parallel to the straight edges of the micro-hole R
AB indicates two areas filled with a horizontal stripe pattern, which represent zones where the accumulated vertical thickness of the beam blocker material S is less than MT, and therefore too thin to satisfactory attenuate vertical radiation beams, i.e. those beams that are parallel to the central axis of the original primary cone beam
AC1 represents the undesirable large max. spacing between radiation beams that are vertical, i.e. parallel to the central axis of the original primary cone beam (Note: AC1 shown in FIG. 10>AC2 shown on Drawing Sheet 8/11, FIG. 11)

Curved edges, on the other hand, minimize this disadvantage by allowing a given radiation beam to pass through the micro-hole, but any radiation beam from the same focal spot or isotope region having a slightly different propagation vector, or any parallel radiation beam that originated at an adjacent focal spot or isotope region, quickly encounters a greater amount of beam blocker material with an accumulated length sufficient to shield and attenuate those unwanted radiation beams.

This is depicted in Drawing Sheet 8/11, FIG. 11, in which:
E represents the original radiation initiation point
S represents the radiation beam blocker material
V represents the micro-hole mask
R represents the micro-hole
MT represents the minimum accumulated thickness of beam blocker material S required to satisfactory attenuate unwanted radiation beams outside of the micro-hole R
AA represents the maximum spacing between angled radiation beams passing through the micro-hole R
AC2 represents the desirable small maximum spacing between radiation beams parallel to the central axis of the original primary cone beam
(Note: AC1 shown on Drawing Sheet 7/11, FIG. 10>AC2 shown in FIG. 11)

Among other requirements, the envelope of the radiation beams or vectors exiting the micro-hole mask must be such that the detection medium in use is sufficiently exposed to radiation. The design and shape of the micro-hole along the thickness of the beam blocker (i.e. along the center axis of the radiation beam) determines both the effective reduction in the radiation initiation point size, as well as the shape of the envelope that encompasses the radiation beams which exit the micro-hole mask and propagate towards the specimen. The micro-hole cross-section design can be adjusted and optimized based on application variables including but not limited to:
Application geometry and setup distances
Distance between the micro-hole mask and the radiation beam initiation point
Size, configuration and localized emission intensity distributions of the original radiation beam initiation point
Desired effective radiation beam cone opening angle and degree of beam collimation
Radiation quality spectrum
Desired size of the effective beam initiation point created by the micro-hole mask

Adjustment of the micro-hole design, its length, diameter and shape configuration can be utilized to create effective initiation points of various sizes, down to a few micrometers or even in the sub-micrometer range.

As long as the narrow region of the micro-hole is in the micrometer diameter range, the resulting effective radiation initiation point created by the micro-hole mask is comparable to that of a microfocus x-ray machine.

While this micro-hole mask reduces the total amount of radiation photons within the primary beam, it does not affect the quality of those photons, which are passing through the micro-hole.

The resulting small effective initiation point defined by the narrow section within the micro-hole, coupled with high quality photons emitted by the original x-ray machine focal spot, linatron, or isotope, allows for examinations that combine high quality radiation with initiation points that are significantly smaller than those commonly used to date. As a result, reducing the effective size of the radiation initiation point of an x-ray machine, linatron, or isotope, according to this invention, allows for examinations of large or dense objects with hard x-rays or high intensity gamma radiation, while at the same time minimizing geometric unsharpness in the radiographic image.

A common x-ray tube with its focal spot and resulting x-ray beam emission is depicted in Drawing Sheet 3/11, FIG. 3, in which:
A represents the effective size of original radiation initiation point or focal spot
E represents the original radiation initiation point, also anode or target
L represents the evacuated tube envelope
M represents the cathode or filament
N represents the electron beam, which is accelerated by high voltage between cathode M and anode E
O represents the outer tube head housing
P represents the tube head window
Q represents the x-ray beam cone opening angle

Because the micro-hole mask blocks a portion of the radiation photons within the primary beam and only allows the remaining portion of the primary beam to pass through the micro-hole, it also acts as a beam collimator. This can result in a reduced need for radiation shielding components such as radiation barriers, reduced personnel exposure to hazardous shielding substances such as lead, and a reduced exposure risk for personnel. The usual cone emitted by a traditional x-ray machine has an opening angle of roughly +20 degrees and −20 degrees off the cone beam center axis, which often results in large radiation fields, especially at increased distances from the x-ray machine tube head, which can result in operational challenges such as shielding requirements, or interruption of adjacent ongoing operations.

The micro-hole mask can be utilized to reduce the effective cone beam opening angle, resulting in a narrower beam opening angle and reduced shielding requirements. However, in many cases it is beneficial to position the micro-hole mask as close as possible to the original radiation initiation point in order to maximize the resulting effective radiation beam cone opening angle. The micro-hole mask can be positioned independently in the primary radiation beam between the x-ray tube head and the specimen. Alternatively, it can be attached to the outside of the tube window of an existing x-ray producing device (e.g. common x-ray tube head or linatron) (Refer to Drawing Sheet 9/11, FIG. 12).

Alternatively, it can be installed inside a tube head between the target and the tube window, in which case it can be located either outside of the evacuated x-ray tube envelope (Refer to Drawing Sheet 10/11, FIG. 13), or inside of the evacuated x-ray tube envelope (Refer to Drawing Sheet 11/11, FIG. 14).

Elements in FIGS. 12, 13, 14 are identified as follows:
E represents the original radiation initiation point, also called anode or target
L represents the evacuated tube envelope
M represents the cathode or filament
N represents the electron beam (accelerated by high voltage between cathode M and anode E)
O represents the outer tube head housing
P represents the tube head window
Q1, Q2, and Q3 represent the resulting x-ray beam cone opening angles for the configurations shown in FIGS. 12, 13, 14 respectively. Note: Q1<Q2<Q3.
V represents the micro-hole mask

The micro-hole mask can be used with any radiation-generating device, as long as the micro-hole is accurately aligned with the existing radiation initiation point. A positioning and mounting mechanism with fine adjustment capabilities can be incorporated in order to position and secure the micro-hole mask in a location where it is accurately aligned with the existing radiation initiation point.

The micro-hole mask can be utilized for static and dynamic radiographic, radioscopic, radiologic, digital imaging, nonfilm imaging, tomographic and laminographic applications.

Preparation and Fabrication of Micro-Hole Mask:

The following fabrication procedure can be utilized to assemble a micro-hole mask in which:
(1) the beam blocker is sufficiently thick to block the desired amount of radiation depending on the beam blocker material as well as the chosen photon quality and quantity,
(2) the envelope encompassing the radiation beams exiting the micro-hole mask is chosen and controlled to ensure that the specimen region and radiation detection medium of interest are sufficiently exposed to radiation,
(3) the micro-hole design and its diameter configuration are chosen and controlled to create an effective initiation point of the desired size, depending on the application and the desired image sharpness.

The thickness of the micro-hole mask can be adjusted by stacking and securing multiple plates on top of each other. In order to maintain the integrity of the micro-hole throughout the entire beam blocker thickness, all plates must have micro-holes with various hole diameters, and all plates must be accurately aligned, for example such that all micro-holes in all plates share a common hole center axis. Each plate has a specific micro-hole diameter and all plates are stacked in a specific order to create e.g. non-cylindrical through-holes with a narrow center section.

The resulting contour of the micro-hole cross section consists of a sequence of steps. The steps approximate a smooth contour. The steps become smaller and finer if a greater amount of thinner individual plates is utilized. All plates can have different thicknesses. The required smoothness of the micro-hole contour, and therefore the required amount of individual plates, as well as the thickness of the individual plates, depends on the application.

Accurate alignment of all plates can be ensured by the use of a base plate with high-precision guiding features, such as pins. All plates to be stacked have according opposite high-precision guiding features, such as holes. The base plate also has a hole aligned with the micro-holes of all other plates. Once stacking is complete, all plates and the base plate are fastened or otherwise secured together to create one solid unit and to prevent relative shifting of the plates.

Refer to Drawing Sheet 6/11, FIGS. 8 and 9, in which:
R represents the micro-hole
W represents the beam blocker stack consisting of all individual plates
X represents multiple high-precision guiding holes within each plate
Y represents multiple high-precision guiding pins as part of the base plate Z
Z represents the base plate

What is claimed is:

1. A radiation beam blocker with a through-hole in the millimeter to sub-micrometer diameter range (complete unit from here on referred to as “Micro-Hole Mask”, and solid region of said micro-hole mask from here on referred to as “Beam Blocker”, and through-hole within said micro-hole mask from here on referred to as “Micro-Hole”), which is positioned in the primary radiation beam emitted by a radiation-generating device, such as an x-ray machine, linatron or radioactive isotope, and utilized during static and dynamic radiographic, radioscopic, radiologic, film imaging, nonfilm imaging, digital imaging, tomographic, laminographic, or other radiation-based inspection and examination applications, as well as fabrication method for said micro-hole mask.

2. The micro-hole mask of claim 1 wherein said beam blocker is made of material, which is highly opaque to x- and/or gamma radiation, and/or has a high x- and/or gamma radiation attenuation coefficient, and/or has a high atomic Z-number (i.e. high number of protons per nucleus), including but not limited to metals, metal alloys, non-metals, composites, plastics, or other materials that meet the above criteria (refer to Drawing Sheet 4/11, FIGS. 4 and 5).

3. The micro-hole mask of claim 1 wherein said beam blocker is sufficiently thick to attenuate the desired amount of radiation (refer to Drawing Sheet 4/11, FIGS. 4 and 5).

4. The micro-hole mask of claim 1 wherein said micro-hole extends along the thickness of said beam blocker, i.e. along the center axis of said radiation beam (refer to Drawing Sheet 4/11, FIGS. 4 and 5).

5. The micro-hole mask of claim 1 wherein the center region of said micro-hole is narrower and has a smaller diameter than the entry and exit holes of said micro-hole (refer to Drawing Sheet 4/11, FIGS. 4 and 5).

6. The micro-hole mask of claim 1 wherein the configuration and cross-section of said micro-hole is designed to allow for radiation beams that were emitted by the original radiation initiation point and that are within a given directional envelope to enter said micro-hole, pass through the narrow center region of said micro-hole without being attenuated or while only being partially attenuated by said beam blocker, exit said micro-hole, and to propagate towards the specimen, as long as said beams emitted by any given sub-region of said original radiation initiation point travel within the desired and acceptable range of propagation directions for each sub-region, while also ensuring that other undesired photons which are emitted from the same sub-region but which travel in other undesired directions are not able to pass through said micro-hole, meaning that they encounter enough material of said beam blocker with an accumulated material length sufficient to shield or attenuate said undesired photons or radiation beams (refer to Drawing Sheet 4/11, FIGS. 4 and 5, and Drawing Sheet 5/11, FIGS. 6 and 7).

7. The micro-hole mask of claim 1 wherein any given specimen feature of interest can only be reached and exposed by photons or radiation beams that were emitted by a specific sub-region of the original radiation initiation point, resulting in a reduction of the “cross-exposure” effect, which is traditionally caused when individual radiation beams that have originated in different sub-regions of said original radiation initiation point follow slightly different propagation vectors, then intersect or cross at the location of said feature within said specimen, then continue to propagate along their respective propagation vectors towards slightly different locations on the radiation detection medium, causing unsharpness in the projection of said feature on the resulting image (refer to Drawing Sheet 2/11, FIG. 2, Drawing Sheet 4/11, FIGS. 4 and 5, and Drawing Sheet 5/11, FIGS. 6 and 7).

8. The micro-hole mask of claim 1 wherein said micro-hole acts as the new effective radiation initiation point for the application, which is smaller than the original radiation initiation point, resulting in reduced geometric unsharpness (refer to Drawing Sheet 5/11, FIGS. 6 and 7).

9. The micro-hole mask of claim 1 wherein the resulting effective initiation point defined by the narrow section within said micro-hole, coupled with the unaffected high quality of the photons emitted by the original x-ray machine focal spot, linatron, or isotope, allows for examinations that combine high quality and high quantity radiation with effective initiation points that are significantly smaller than those commonly used to date, as well as for examinations of large or dense objects with hard, high flux and high intensity x-rays or gamma radiation, while at the same time minimizing geometric unsharpness in the radiographic image (refer to Drawing Sheet 5/11, FIGS. 6 and 7).

10. The micro-hole mask of claim 1 wherein the diameter and cross-section of said micro-hole can vary along the thickness of said beam blocker (i.e. along the center axis of the radiation beam) in any straight, linear, non-linear, rounded, symmetric, and/or asymmetric fashion, which determines both the effective reduction in the radiation initiation point size, as well as the shape of the envelope that encompasses the radiation beams which exit said micro-hole mask and propagate towards the specimen (refer to Drawing Sheet 4/11, FIGS. 4 and 5).

11. The micro-hole mask of claim 1 wherein a non-linear and curved cross-section design of said micro-hole optimizes its effectiveness; because as a result, any unwanted radiation beam traveling outside of the desired envelope of acceptable propagation directions will quickly encounter enough material of said beam blocker with an accumulated material length sufficient to shield and attenuate said unwanted radiation beam, regardless of its propagation direction or the radiation initiation point sub-region from which it was emitted. This optimized performance of said curved micro-hole design becomes apparent when Drawing Sheet 7/11, FIG. 10, and Drawing Sheet 8/11, FIG. 11 are compared, which illustrate that spacing AC1 in FIG. 10 is larger and therefore less desirable than spacing AC2 in FIG. 11.

12. The micro-hole mask of claim 1 wherein said micro-hole design, its length, diameter and shape configuration can be designed and optimized based on application variables including but not limited to: application geometry; setup distances; distance between said micro-hole mask and the radiation beam initiation point; size, configuration and localized emission intensity distributions of the original radiation beam initiation point; desired effective radiation beam cone opening angle and degree of beam collimation; radiation quality spectrum; or desired size of the resulting effective beam initiation point down to a few micrometers or even in the sub-micrometer range (refer to Drawing Sheet 4/11, FIGS. 4 and 5, and Drawing Sheet 5/11, FIGS. 6 and 7).

13. The micro-hole mask of claim 1 wherein, depending on the design of said micro-hole, either the entire radiation initiation point, i.e. focal spot or isotope, or only certain sub-regions of said initiation point, can emit photons that can pass through said micro-hole without being attenuated, as long as said photons travel within the appropriate range of propagation directions for each sub-region (refer to Drawing Sheet 5/11, FIGS. 6 and 7).

14. The micro-hole mask of claim 1 wherein said micro-hole mask is located between the original radiation initiation point of the radiation-generating device and the specimen under examination, preferably as close to said original radiation initiation point as possible in order to maximize the resulting effective radiation beam cone opening angle available for the application (refer to Drawing Sheet 9/11, FIG. 12, Drawing Sheet 10/11, FIG. 13, and Drawing Sheet 11/11, FIG. 14).

15. The micro-hole mask of claim 1 wherein said micro-hole mask can be positioned temporarily and independently in said primary radiation beam (e.g. between said x-ray tube head or isotope and the specimen), while positioning and mounting mechanisms with fine adjustment capabilities can be incorporated in order to position and secure said micro-hole mask in a location where it is accurately aligned with the original radiation initiation point of said radiation-generating device used for the application (refer to Drawing Sheet 9/11, FIG. 12).

16. The micro-hole mask of claim 1 wherein said micro-hole mask can be temporarily or permanently attached to the outside of the accessible emission port of said radiation-generating device (e.g. tube window of common x-ray tube head or linatron), while positioning and mounting mechanisms with fine adjustment capabilities can be incorporated in order to position and secure said micro-hole mask in a location where it is accurately aligned with the original radiation initiation point of said radiation-generating device used for the application (refer to Drawing Sheet 9/11, FIG. 12).

17. The micro-hole mask of claim 1 wherein said micro-hole mask can be installed inside of said radiation-generating device (e.g. inside of an x-ray tube head between the x-ray initiation point, i.e. electron bombardment target, and the tube emission window, or inside of a linatron assembly), in which case said micro-hole mask can be located either outside of the evacuated x-ray tube envelope or located inside of the evacuated x-ray tube envelope if such evacuated envelopes are part of the x-ray producing device, while positioning and mounting mechanisms with fine adjustment capabilities can be incorporated in order to position and secure said micro-hole mask in a location where it is accurately aligned with the original radiation initiation point of said radiation-generating device used for the application (refer to Drawing Sheet 10/11, FIG. 13, and Drawing Sheet 11/11, FIG. 14).

18. A fabrication method for the micro-hole mask of claim 1 wherein multiple separate plates of varying or similar thicknesses, and with specific individual micro-holes diameters are stacked on top of each other in a specific sequence, until the thickness of said beam blocker is such that it is sufficiently thick to block the desired amount of radiation depending on the material of said beam blocker as well as the chosen photon quality and quantity of the application (refer to Drawing Sheet 6/11, FIGS. 8 and 9).

19. A fabrication method in accordance with claim 18 wherein multiple separate plates with specific individual micro-hole diameters are stacked on top of each other in a specific sequence, allowing to control all design aspects of said micro-hole, to ensure that the shape of the envelope that encompasses the radiation beams which enter and exit said micro-hole mask is adequate to sufficiently expose the specimen region and radiation detection medium of interest to radiation, and to ensure that said micro-hole and its design configuration create an effective radiation initiation point of the desired size, depending on the application and the desired image sharpness (refer to Drawing Sheet 6/11, FIGS. 8 and 9).

20. A fabrication method in accordance with claim 18 wherein all said separate plates are accurately aligned relatively to each other, for example such that all micro-holes in all plates share a common hole center axis, which can be accomplished by using a base plate having its own micro-hole and having multiple high-precision guiding features such as pins, that are oriented normally to the base plate, while all remaining plates to be stacked have according opposite high-precision guiding features such as holes which slide onto the base plate's pins, followed by another operation during which all said plates and said base plate are fastened or otherwise secured together once stacking is complete, which can be accomplished by methods including but not limited to soldering, welding, adhesives, brackets, casings, or implementing threads on the ends of said base plate's guiding pins to allow the engagement of threaded nuts to secure the assembly, to create one solid unit, to ensure long-term alignment, and to prevent relative shifting of said individual plates (refer to Drawing Sheet 6/11, FIGS. 8 and 9).
